(19) United States
(12) Patent Application Publication
(10) Pub. No.: US 2025/0371902 A1
(43) Pub. Date: Dec. 4, 2025

(54) CHART DE-RENDERING SYSTEM, METHOD, AND PROGRAM FOR EXTRACTING META INFORMATION AND DATA INFORMATION FROM CHART USING ARTIFICIAL INTELLIGENCE

(71) Applicant: LG MANAGEMENT DEVELOPMENT INSTITUTE CO., LTD., Seoul (KR)

(72) Inventors: Kwangrok RYOO, Seoul (KR); Seungjun LEE, Seoul (KR); Soonyoung LEE, Seoul (KR)

(21) Appl. No.: 19/302,563

(22) Filed: Aug. 18, 2025

Related U.S. Application Data
(63) Continuation of application No. PCT/KR2025/001512, filed on Jan. 24, 2025.

(30) Foreign Application Priority Data
Jan. 25, 2024 (KR) 10-2024-0011842

(51) Int. Cl. G06V 30/416; G06T 11/00; G06V 10/40; G06V 10/70; G06V 30/18; G06V 30/19; G06V 30/30

(52) U.S. Cl. CPC G06V 30/416; G06T 11/00; G06V 10/40; G06V 10/70; G06V 30/18162; G06V 30/191; G06V 30/30; G06T 2210/32; G06V 2201/10

(57) ABSTRACT

Provided is a system for implementing an artificial intelligence (AI) model for extracting meta information and data information included in a chart. The system includes at least one processor; and at least one memory storing instructions for the processor. The processor is configured to input the chart into an image encoder to convert the chart into a first embedding processable by the AI model, input the first embedding to the AI model to output a second embedding including the meta information from the first embedding, and to output a fourth embedding including the data information from a third embedding including information about an entity included in the second embedding, and output each of a first data format in which the meta information included in the second embedding is recorded, and a second data format in which the data information included in the fourth embedding is recorded.

### CROSS REFERENCE TO RELATED APPLICATION

This application is a Bypass Continuation of International Patent Application No. PCT/KR2025/001512, filed on Jan. 24, 2025, which claims priority from and the benefit of Korean Patent Application No. 10-2024-0011842, filed on Jan. 25, 2024, which is hereby incorporated by reference for all purposes as if fully set forth herein.

### BACKGROUND

### Field

Embodiments of the invention generally relate to a chart de-rendering system, method, and program for extracting meta information and data information included in a chart, and more particularly, to a chart de-rendering system, method, and program capable of extracting meta information and data information included in a chart using artificial intelligence.

### Discussion of the Background

Charts included in papers, reports, textbooks, and the like are generally generated through a process of transmitting data tables set by numbers and groups, and code defining an overall layout (e.g., type, orientation, color/shape configuration, etc.) to a rendering engine.

Chart de-rendering refers to a process opposite to chart rendering, in which visual patterns or information of a chart are analyzed and grouped to extract key information, and information about data (e.g., numbers, groups, etc.) and information about chart layout is extracted from the key information.

A rule-based model was used in an initial chart de-rendering process. The rule-based model refers to a model that extracts information of the chart using predefined functions (e.g., color detection, chart axis value extraction, etc.) and combines or analyzes each piece of information using predefined rules. The rule-based model has an advantage of excellent accuracy, but has a disadvantage of lacking scalability due to the requirement of separate models for each type of chart.

In order to compensate for the disadvantage, a generative model method using a single trained artificial intelligence (AI) has been introduced (DePlot: One-shot visual language reasoning by plot-to-table translation. In Findings of the Association for Computational Linguistics: ACL 2023, pages 10381-10399). The generative model can be easily applied to all types of charts with a single model, unlike the rule-based model, thereby providing improved scalability.

However, a conventional generative model used a method of including meta information (e.g., names of X-axis and Y-axis, names of entity (a single unit of data) groups recorded in a legend, etc.) and data information (e.g., numerical values of the X-axis and/or Y-axis of each entity, etc.) in a single data format without distinguishing between them. For example, as shown in FIG. 6, a title of a chart (Meta Chart), a name of an X-axis (Epoch), a name of a Y-axis (Experiment result), X-axis (Epoch) values of [1, 2, 3, 4, 5], and all Y values (i.e., [10, nan, 30, nan, 50] for Model 1 and [1, 4, 9, 16, 25] for Model 2) of each entity (Model 1 and Model 2), which correspond to the X-axis (Epoch) values, are recorded in a single data format. Such a data format includes a large amount of represented information, which makes data representation complex, has a constraint of having to represent all Y values dependent on each X value, and has problems such as a high possibility of format errors because an entity value (e.g., “nan” value) is not identified.

The conventional generative model generally treated numbers as text. As a result, numbers are represented using a method of dividing a single number into irregular units, splitting each unit into multiple tokens, and inputting the tokens. Such a method uses an unnecessarily large number of tokens to represent a single number (e.g., when representing the number 13.1, since “1” and “3.1” are represented by being input as separate tokens, a total of two tokens are needed). Accordingly, a conventional language model used an unnecessarily large number of tokens, resulting in token waste or a decrease in inference speed.

The above information disclosed in this Background section is only for understanding of the background of the inventive concepts, and, therefore, it may contain information that does not constitute prior art.

### SUMMARY

An objects of the invention is directed to providing a system, method, and program capable of efficiently and accurately extracting numerical information while providing a data format that simply represents the content of data included in a chart.

Objects of the invention are not limited to the above-described object, and other objects that are not mentioned will be clearly understood by those skilled in the art from the following description.

Additional features of the inventive concepts will be set forth in the description which follows, and in part will be apparent from the description, or may be learned by practice of the inventive concepts.

A system for implementing an artificial intelligence (AI) model for extracting meta information and data information included in a chart according to the embodiments of the invention may include at least one processor, and at least one memory storing instructions for execution by the at least one processor, wherein the at least one processor is configured to input the chart into an image encoder to convert the chart into a first embedding processable by the AI model, input the first embedding to the AI model to output a second embedding including the meta information from the first embedding, and to output a fourth embedding including the data information from a third embedding including information about an entity included in the second embedding, and output each of a first data format in which the meta information included in the second embedding is recorded and a second data format in which the data information included in the fourth embedding is recorded.

In the system, the data information included in the fourth embedding may be distinguished for each entity.

In the system, the meta information may include a title of the chart, a name of an axis, and a name of the entity included in a legend.

In the system, the data information may include numerical information included in the chart.

In the system, each of the data information may be tokenized into a single token and included in the fourth embedding, and in recording the data information included in the fourth embedding in the second data format, the tokenized data information may be extracted from single tokens and recorded in the second data format.

In the system, the data information may be extracted from single tokens using a multi-layer perceptron (MLP).

In the system, in extracting the data information from the single tokens, data information may be simultaneously extracted by inputting the single tokens with a predefined repetitive template.

A method for extracting meta information and data information included in a chart according to another aspect of the invention may include inputting the chart to an image encoder to convert the chart into a first embedding processable by an artificial intelligence (AI) model, inputting the first embedding to the AI model to output a second embedding including the meta information from the first embedding, outputting a fourth embedding including the data information from a third embedding including information about an entity included in the second embedding, and outputting each of a first data format in which the meta information included in the second embedding is recorded and a second data format in which the data information included in the fourth embedding is recorded.

In the method, the data information included in the fourth embedding may be distinguished for each entity.

In the method, the meta information may include a title of the chart, a name of an axis, and a name of the entity included in a legend.

In the method, the data information may include numerical information included in the chart.

In the method, each data item of the data information may be tokenized into a single token and included in the fourth embedding, and in recording the data information included in the fourth embedding in the second data format, a tokenized data information may be extracted from single tokens and recorded in the second data format.

In the method, the data information may be extracted from the single tokens using a multi-layer perceptron (MLP).

In the method, in extracting the data information from the single tokens, data information may be simultaneously extracted by inputting the single tokens with a predefined repetitive template.

A program stored in a computer-readable recording medium, which, when executed by a computer, may cause the computer to perform a method comprising: inputting the chart to an image encoder to convert the chart into a first embedding processable by an artificial intelligence (AI) model; inputting the first embedding to the AI model to output a second embedding including the meta information from the first embedding; outputting a fourth embedding including the data information from a third embedding including information about an entity included in the second embedding; and outputting each of a first data format in which the meta information included in the second embedding is recorded, and a second data format in which the data information included in the fourth embedding is recorded.

According to the embodiments of the invention, since a length of each data format is shortened by separately extracting meta data, the content of data can be simply represented, and accordingly, a possibility of format errors can be reduced.

According to the embodiments of the invention, since raw data is independently represented by distinguishing the raw data for each entity, there is no need to input a “nan” value that is difficult to process for an empty data value, thereby minimizing format errors caused by failure to identify the “nan” value or optimizing token usage.

According to the embodiments of the invention, since each number included in the entities of a chart is output using a single token (<num>), the separation of tasks between text understanding and data extraction can be facilitated, and the number of tokens representing numbers can be reduced, thereby enabling efficient training and prediction in a model.

According to the embodiments of the invention, since a sufficient length of “<num>” tokens is provided in advance, the necessity for autoregressive transfer can be minimized, and furthermore, the inference speed can be significantly improved.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic diagram of a system for implementing an artificial intelligence (AI)-based chart de-rendering method according to one embodiment of the invention.

FIG. 2 is a schematic block diagram for explaining a configuration of a device performing the AI-based chart de-rendering method according to one embodiment of the invention.

FIG. 3 is a schematic block diagram for explaining a method of extracting meta information and data information from a chart according to embodiments of the invention.

FIG. 4 is a schematic conceptual diagram for explaining a method of representing the number “−0412920” in an embedding through a singularized number embedding (SNE) method according to embodiments of the invention.

FIG. 5A is a schematic conceptual diagram showing a method of recognizing and representing numbers in an autoregressive method in a conventional language model.

FIG. 5B is schematically showing a method of recognizing and representing numbers in the autoregressive method through the SNE method according to embodiments of the invention.

FIG. 5C is schematically showing a method of recognizing and representing numbers in a non-autoregressive method using a repetitive template through the SNE method according to embodiments of the invention.

FIG. 6 is a schematic example of a data format used in a conventional generative model.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Terms such as first and second are used to distinguish one component from another, and the components are not limited by the above-described terms.

A singular expression includes plural expressions unless the context clearly dictates otherwise.

In each operation, identification symbols are used for convenience of explanation, and the identification symbols do not describe the sequence of each operation, and each operation may be performed in a different sequence from the specified sequence unless a specific sequence is clearly described in context.

A chart de-rendering system according to the embodiments of the invention may include a device, and the device may include all kinds of devices that can perform computational processing to provide results to a user. For example, the chart de-rendering system according to the embodiments of the invention may include at least one of a computer, a server device, and a portable terminal, or may be implemented in any one form having the same or similar functions thereof. However, the invention is not limited thereto.

Here, the computer may include, for example, a notebook, a desktop, a laptop, a tablet PC, a slate PC, etc., which are equipped with a web browser.

The server device may be a server that processes information in communication with an external device, and may include an application server, a computing server, a database server, a file server, a game server, a mail server, a proxy server, and a web server.

The portable terminal may be, for example, a wireless communication device ensuring portability and mobility and may include all kinds of handheld-based wireless communication devices such as a personal communication system (PCS), a global system for mobile communications (GSM), a personal digital cellular (PDC), a personal handphone system (PHS), a personal digital assistant (PDA), international mobile telecommunication-2000 (IMT-2000), code division multiple access-2000 (CDMA-2000), w-code division multiple access (W-CDMA), a wireless broadband internet (WiBro) terminal, a smart phone, and wearable devices such as a watch, a ring, a bracelet, an anklet, a necklace, glasses, contact lenses, or a head-mounted device (HMD).

Hereinafter, embodiments of the invention will be described in detail with reference to the accompanying drawings.

The invention may relate to a chart de-rendering system, method, and program for extracting meta information and data information included in a chart, and more particularly, to a chart de-rendering system, method, and program capable of extracting meta information and data information included in a chart using artificial intelligence.

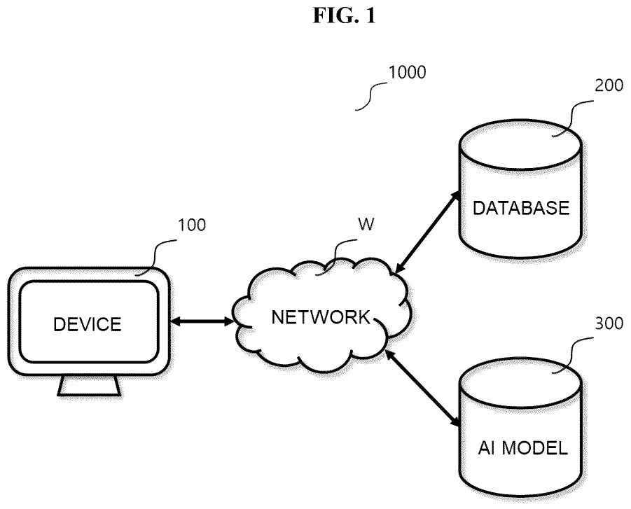

FIG. 1 is a schematic diagram of a system that can implement a method for de-rendering a chart according to one embodiment of the invention.

As shown in FIG. 1, a system 1000 may include a device 100, a database 200, and an artificial intelligence (AI) model 300.

The device 100, the database 200, and the AI model 300 that are included in the system 1000 may perform communication via a network W. Here, the network W may include a wired network and a wireless network. For example, the network may include various networks such as a local area network (LAN), a metropolitan area network (MAN), and a wide area network (WAN).

The network W may include the well-known world wide web (WWW). However, the network W according to embodiments of the invention is not limited to the above-listed networks and may include, at least in part, a well-known wireless data network, a well-known telephone network, or a well-known wired and wireless television network.

The device 100 may input the chart and output information about the chart based on the AI model 300.

A form of the chart input to the AI model 300 may be a vertical/horizontal bar chart, a line chart, a pie chart, an area chart, a scatter chart, a radar chart, a histogram, and/or a waterfall chart. The form of the chart may be a single form or a combined form of a plurality of forms. However, the chart used in the invention is not limited thereto, and the chart may include any form of chart. The chart may include text information in addition to information (e.g., lines, circles, etc.) that visualizes numerical values, etc., and may include annotation information of the chart, a legend or title of the chart, a name of each axis (e.g., X-axis, Y-axis, Z-axis, etc.), numerical values of raw data of points included in the chart (e.g., numerical values of X-axis and Y-axis of points included in the chart), etc.

Information about the chart output from the AI model 300 may be information that represent features of the chart and include meta information, data information, etc. The meta information may include the names of X-axis and Y-axis, a name of an entity recorded in the legend, etc. The data information may include numerical values of X-axis and/or Y-axis of each entity, etc.

According to the embodiments of the invention, when outputting information about the chart based on an obtained chart (e.g., an image), the device 100 may separately output meta information and data information included in the information about the chart.

The database 200 may store various training data that trains the AI model 300. The database 200 may store a chart image, the information about the chart, etc., and in various embodiments, may store output data output by the AI model 300. However, the system 1000 may not include the database 200 when the training of the AI model 300 is completed.

FIG. 1 shows a case in which the database 200 is implemented outside the device 100. For example, the database 200 may be connected to the device 100 in a wired or wireless communication manner. However, this is only one embodiment, and the database 200 may also be implemented as one component of the device 100.

FIG. 1 shows a case in which the AI model 300 is implemented outside the device 100 (e.g., implemented in a cloud-based manner), but is not limited thereto, and may be implemented as one component of the device 100.

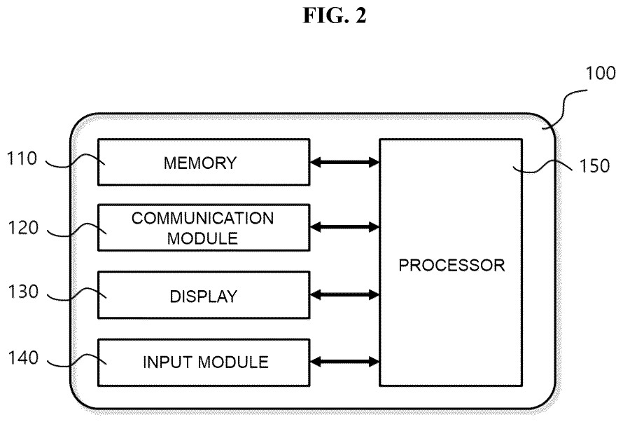

FIG. 2 is a schematic block diagram for explaining a configuration of a device performing a method for extracting meta information and data information of a chart using artificial intelligence using artificial intelligence (AI) according to one embodiment of the invention.

As shown in FIG. 2, the device 100 may include a memory 110, a communication module 120, a display 130, an input module 140, and a processor 150. However, the invention is not limited thereto, and software and hardware components of the device 100 may be modified/added/omitted according to a required operation within a scope obvious to those skilled in the art. The device 100 may be replaced with a system, and the device 100 may include a plurality of devices and for example, each component included in the device 100 may be included in at least one of the plurality of devices.

The memory 110 may store data supporting various functions of the device 100 and a program for the operation of the processor 150, store input/output data, and store a plurality of application programs or applications that are driven on the present device, data, command and the AI model for the operation of the device 100. At least some of the application programs may be downloaded from an external server via wireless communication.

The memory 110 may include at least one type of storage medium among a flash memory type, a hard disk type, a solid state disk type (SSD type), a silicon disk drive type (SDD type), a multimedia card micro type, a card-type memory (e.g., an SD or XD memory), a random access memory (RAM), a static random access memory (SRAM), a read-only memory (ROM), an electrically erasable programmable ROM (EEPROM), a programmable ROM (PROM), a magnetic memory, a magnetic disk, and an optical disk.

The memory 110 may be separated from the device 100, and may include a database that connected in a wired or wireless communication manner. The database 200 shown in FIG. 1 may be implemented as one component of the memory 110.

The communication module 120 may include one or more components that enable communication with an external device, and may include at least one of, for example, a broadcasting reception module, a wired communication module, a wireless communication module, a short-range communication module, or a position information module.

The wired communication module may include not only various wired communication modules such as a local area network (LAN) module, a wide area network (WAN) module, and a value added network (VAN) module, but also various cable communication modules such as a universal serial bus (USB), a high definition multimedia interface (HDMI), a digital visual interface (DVI), a recommended standard 232 (RS-232), power line communication, and plain old telephone service (POTS).

In addition to the WiFi module and the wireless broadband (WiBro) module, the wireless communication module may include a wireless communication module for supporting various wireless communication methods such as global system for mobile communication (GSM), code division multiple access (CDMA), wideband CDMA (WCDMA), universal mobile telecommunications system (UMTS), time division multiple access (TDMA), long term evolution (LTE), 4G, 5G, or 6G.

The display 130 may display (or output) information or data that are processed in the device 100 and data that are input or output through the AI model 300, etc. The display 130 may display execution screen information of an application program (e.g., an application) driven on the device 100, or user interface (UI) or graphic user interface (GUI) information according to such execution screen information.

The input module 140 may receive information from a user or any external source, and when receiving information through a user or any external source, the processor 150 may control the operation of the device 100 to correspond to the input information.

The input module 140 may include a hardware physical key (e.g., a button located on at least one of a front surface, a back surface, and a side surface of the present device, a dome switch, a jog wheel, or a jog switch, etc.) and a software touch key. For example, the touch key may be formed as a virtual key, a soft key, or a visual key that is displayed on a touchscreen type of the display 130 through software processing or may be formed as the touch key disposed a portion other than the touchscreen. Meanwhile, the virtual key or visual key may have various forms and may be displayed on the touchscreen, and may be formed as, for example, a graphic, text, an icon, a video, or a combination thereof.

The processor 150 may be located adjacent to the memory 110, the communication module 120, the display 130, and the input module 140 and may be electrically connected to the memory 110, the communication module 120, the display 130, and the input module 140. The processor 150 may be implemented with the memory 110 that stores data for an algorithm for controlling the operations (including learning or execution of the AI model) of the components in the device 100 or a program that reproduces the algorithm, and at least one processor (not shown) that performs the above-described operation using the data stored in the memory. For example, the memory 100 and the processor 150 may be implemented as separated chips or may be implemented as a single chip.

In one embodiment, the system 1000 or the device 100 according to the embodiments of the invention may include at least one processor, and when including a plurality of processors, the plurality of processors may be included in different devices 100.

The processor 150 may control the operations of the components by combining any one or a plurality of the above-described components in order to implement various embodiments according to the embodiments of the invention, which will be described below, on the device 100.

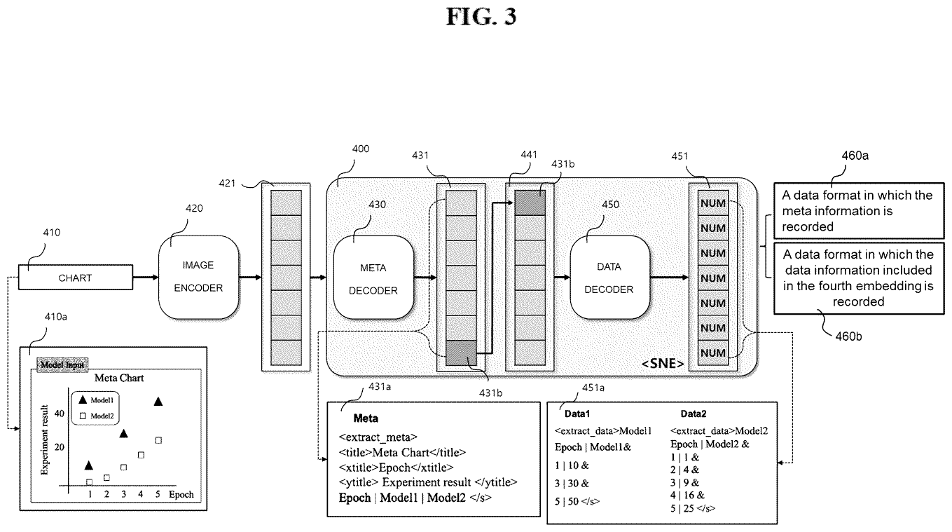

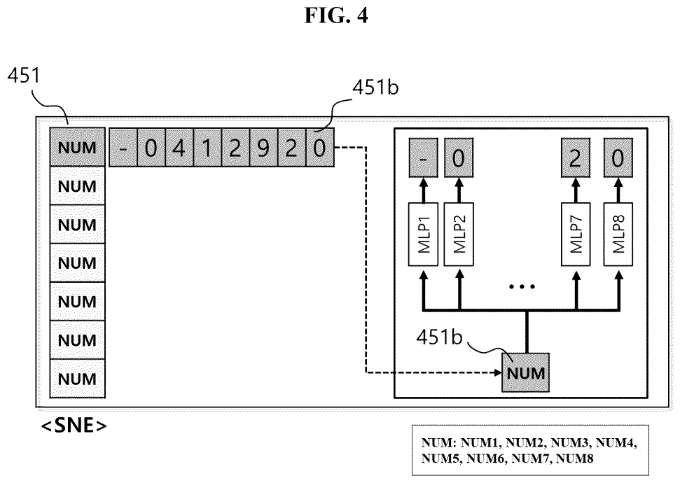

FIG. 3 is a schematic block diagram for explaining a method of extracting the meta information and the data information from a chart according to embodiments of the invention. FIG. 4 is a schematic conceptual diagram for explaining a method of representing the number “−0412920” in an embedding through a singularized number embedding (SNE) method according to embodiments of the invention.

Referring to FIG. 3, a chart 410 including a title of a chart, axis names, legend information, numerical values, etc. may be input to an image encoder 420. As described above, a form of the chart 410 may be a vertical/horizontal bar chart, a line chart, a pie chart, an area chart, a scatter chart, a radar chart, a histogram, and/or a waterfall chart, but is not limited thereto. The form of the chart may be a single form or a combined form of a plurality of forms. For example, an input chart 410a shown in FIG. 3 may be used as the chart 410.

The image encoder 420 may be an encoder following a generally used encoder architecture, which is implemented as an AI model such as ViT or ResNet, but is not limited thereto. The image encoder 420 may serve to convert the input chart 410a into a first embedding 421 that is processed by the AI model 300.

The first embedding 421 generated (or output) from the image encoder 420 may be input to an artificial intelligence (AI) module 400 including a meta decoder 430 for performing a meta decoding task and a data decoder 450 for performing data decoding.

The first embedding 421 may be decoded through the meta decoder 430, which operates in an autoregressive method. The meta decoder 430 may recognize the meta information from the embedding 421 such as names (or titles) of X-axis and Y-axis, names (or titles) of entities recorded in a legend, etc., but the recognized meta information is not limited thereto. The meta decoder 430 may generate (or output) a second embedding 431 including the recognized meta information. For example, in the case of using the input chart 410a, the second embedding 431 may include a chart name (or title) (<title>Meta Chart</title>), an X-axis name (or title) (<xtitle>Epoch</xtitle>), a Y-axis name (or title) (<ytitle>Experiment result</ytitle>), and a list of entities recorded in the legend (Epoch|Model1|Model2), as shown in an embedding 431a.

The invention, by separately extracting the meta information from the data information described below, may have effects in which a length of each data format is shortened, allowing the content of data to be simply represented, and thereby, reducing the possibility of format errors.

Among the information included in the second embedding 431, information 431b about an entity may serve as a prompt that guides the data decoder 450 decoding the data in the AI model module 400 to output an embedding including raw data. When the information 431b about the entity is input to the data encoder as a third embedding 441, a fourth embedding 451 including raw data for each entity may be output. For example, the fourth embedding 451 may generate raw data in a format of [x1|y1 &; x2|y2 &; . . . xn|yn &; </s>], and may distinguish and independently represent raw data for each entity. For example, when the input chart 410a shown in FIG. 3 is used, as shown in an output embedding 451a, raw data for Model 1 ([1|10 &; 3|30 &; 5|50 & </s>]) may be represented, and raw data for Model 2 ([1|1 &; 2|4 &; 3|9 & 4|16 &; 5|25 &</s>]) may be independently represented.

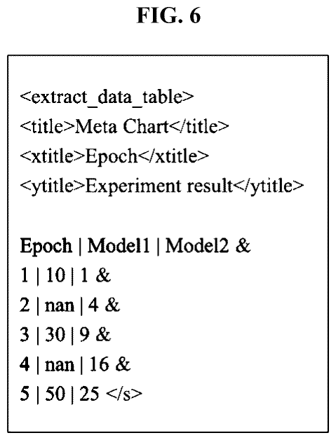

In the invention, the data format output, when the input chart 410a is the input, may differ from that of the conventional generative model as follows. In order to indicate that, when a value of Epoch in the input chart 410a is 2, Model 2 may have a value of “4” while Model 1 may have no value, the conventional generative model may input the value of “4” for Model 2 and may input a “nan” value for Model 1 to indicate an empty value (see FIG. 6). In contrast, the invention may represent the data in a manner where, since the output embedding 451a independently represents the raw data for each entity, the data related to Model 1 simply does not define the case in which the value of Epoch is 2. That is, the invention may not generate (or output) the “nan” value, which frequently causes errors in the system processing.

The invention, by using a data format in which data independently represents for each entity, may have effects in which the need to input the “nan” value that is difficult to process for an empty data value is eliminated, thereby minimizing format errors caused by failure to identify the “nan” value, and optimizing token usage by eliminating the need to allocate a token for the “nan” value.

Here, the invention may use a singularized number embedding (SNE) method as a method for representing numbers in the fourth embedding 451 (which contrasts with the conventional generative model that treats numbers as text). The SNE method may refer to a method in which each number included in the entity is tokenized into a single token (<num>) in the data decoder 450 for decoding data in the AI model module 400, and the number may be output to the fourth embedding 451 using the token.

A multi-layer perceptron (MLP) may be used as a method for extracting numbers using the tokenized single token (<num>). Here, the MLP may be composed of an input layer, one or more hidden layers, and an output layer, and each layer may include weights and an activation function. The weights used in the MLP of the invention may be pre-optimized through a training algorithm to predict nonlinear patterns and relationships.

For example, as shown in FIG. 4, in the case of representing the number “−0412920” in an embedding through the SNE method, each number included in the entity may be tokenized into a single token (<num>) 451b through the data decoder 450 decoding data in the AI model module 400, and each token 451b may be the input to the MLP (MLP1, MLP2, MLP3, MLP4, MLP5, MLP6, MLP7, MLP8) to represent the number on the fourth embedding 451. In this case, the number of the MLP may have eight, but is not limited thereto. In another embodiment, the number of the MLP may be less or greater than eight.

The invention, through this manner, may expect additional performance improvement by facilitating the separation of tasks between text understanding and data extraction, may enable efficient training and prediction in the model by reducing the number of tokens representing numbers, and may greatly improve inference speed by repeatedly using the <num>token.

Meanwhile, the invention may further improve the inference speed by outputting numbers through inputting tokens used in the SNE method with a predefined repetitive template.

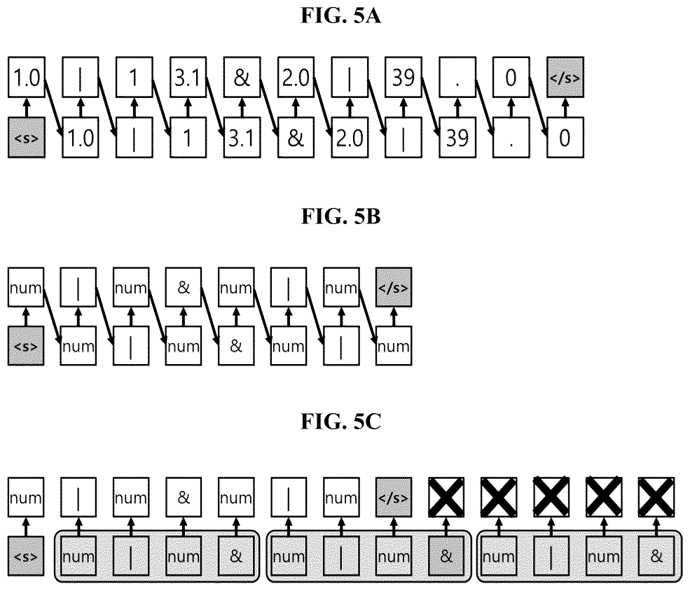

FIG. 5A is a schematic conceptual diagram showing a method of recognizing and representing numbers in an autoregressive method in a conventional language model. FIG. 5B is schematically showing a method of recognizing and representing numbers in the autoregressive method through the SNE method according to embodiments of the invention. FIG. 5C is schematically showing a method of recognizing and representing numbers in a non-autoregressive method using a repetitive template through the SNE method according to embodiments of the invention. FIG. 6 is a schematic example of a data format used in a conventional generative model.

Referring to FIG. 5A, a conventional language model may treat numbers as text and may use an autoregressive method in which each token is sequentially predicted. The method may infer numbers by sequentially supplying a token at time step to the model and generating outputs until an end of sentence (EOS) token (</s>) is reached. As described above, this method causes problems of token waste and reduced inference speed.

This problem may be partially improved by representing numbers in an autoregressive manner using a single token <num> through the SNE method, as shown in FIG. 5B.

As shown in FIG. 5C, performance may be further improved by additionally providing a non-autoregressive method that simultaneously infers multiple numbers by inputting a plurality of <num> tokens at once with a predefined repetitive template when inferring numbers using the token <num> (for example, when inputting the tokens <num> through the repetitive template, outputs after the EOS token (</s>) is first output are discarded).

Through this manner, AI models according to embodiments of the invention may supply a sufficient length “<num>” tokens in advance, thereby minimizing the necessity for autoregressive transfer, and furthermore, significantly improving the inference speed.

As such, through the processing using the AI model, a data format 460a in which the meta information is recorded and a data format 460b in which the data information included in the fourth embedding is recorded may be each ultimately obtained.

Meanwhile, the method of extracting the meta information and the data information from the chart according to embodiments of the invention may be implemented by the system described with reference to FIG. 3.

AI models according to embodiments of the invention may be controlled, executed, trained, driven, etc. by the processor, and accordingly, at least one of the tasks of executing, training, and driving the AI models may be performed by at least one processor. The AI models may be stored in the memory, and the feature data according to the embodiments of the invention may also be stored in memory.

Meanwhile, disclosed embodiments may be implemented in the form of a recording medium in which computer-executable commands are stored. The commands may be stored in the form of program code, and when executed by the processor, program modules may be generated to perform operations of the disclosed embodiments. The recording medium may be implemented as a computer-readable recording medium.

The computer-readable recording medium includes all types of recording media in which computer-decodable commands are stored. For example, there may be a read only memory (ROM), a random access memory (RAM), a magnetic tape, a magnetic disk, a flash memory, an optical data storage device, and the like.

As described above, the disclosed embodiments have been described with reference to the accompanying drawings. Those skilled in the art to which the invention pertains will understand that the invention may be implemented in different forms from the disclosed embodiments without departing from the technical spirit or essential features of the invention. The disclosed embodiments are illustrative and should not be construed as being limited.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A system for implementing an artificial intelligence (AI) model for extracting meta information and data information included in a chart, the system comprising:
at least one processor; and
at least one memory storing instructions for execution by the at least one processor,
wherein the at least one processor is configured to:
input the chart into an image encoder to convert the chart into a first embedding processable by the AI model;
input the first embedding to the AI model to output a second embedding including the meta information from the first embedding, and to output a fourth embedding including the data information from a third embedding including information about an entity included in the second embedding; and
output each of a first data format in which the meta information included in the second embedding is recorded, and a second data format in which the data information included in the fourth embedding is recorded.

2. The system of claim 1, wherein the data information included in the fourth embedding is distinguished for each entity.

3. The system of claim 1, wherein the meta information includes a title of the chart, a name of an axis, and a name of the entity included in a legend.

4. The system of claim 1, wherein the data information includes numerical information included in the chart.

5. The system of claim 1, wherein each of the data information is tokenized into a single token and included in the fourth embedding, and
in recording the data information included in the fourth embedding in the second data format, a tokenized data information is extracted from single tokens and recorded in the second data format.

6. The system of claim 4, wherein the data information is extracted from single tokens using a multi-layer perceptron (MLP).

7. The system of claim 5, wherein
in extracting the data information from the single tokens, data information is simultaneously extracted by inputting the single tokens with a predefined repetitive template.

8. A method for extracting meta information and data information included in a chart, the method comprising:
inputting the chart to an image encoder to convert the chart into a first embedding processable by an artificial intelligence (AI) model;
inputting the first embedding to the AI model to output a second embedding including the meta information from the first embedding;
outputting a fourth embedding including the data information from a third embedding including information about an entity included in the second embedding; and
outputting each of a first data format in which the meta information included in the second embedding is recorded, and a second data format in which the data information included in the fourth embedding is recorded.

9. The method of claim 8, wherein the data information included in the fourth embedding is distinguished for each entity.

10 The method of claim 8, wherein the meta information includes a title of the chart, a name of an axis, and a name of the entity included in a legend.

11. The method of claim 8, wherein the data information includes numerical information included in the chart.

12. The method of claim 8, wherein each data item of the data information is tokenized into a single token and included in the fourth embedding, and
in recording the data information included in the fourth embedding in the second data format, a tokenized data information is extracted from single tokens and recorded in the second data format.

13. The method of claim 12, wherein the data information is extracted from the single tokens using a multi-layer perceptron (MLP).

14. The method of claim 12, wherein in extracting the data information from the single tokens, data information is simultaneously extracted by inputting the single tokens with a predefined repetitive template.

15. A program stored in a computer-readable recording medium, which, when executed by a computer, causes the computer to perform a method comprising:
inputting the chart to an image encoder to convert the chart into a first embedding processable by an artificial intelligence (AI) model;
inputting the first embedding to the AI model to output a second embedding including the meta information from the first embedding;
outputting a fourth embedding including the data information from a third embedding including information about an entity included in the second embedding; and
outputting each of a first data format in which the meta information included in the second embedding is recorded, and a second data format in which the data information included in the fourth embedding is recorded.

16. The program of claim 15, wherein the data information included in the fourth embedding is distinguished for each entity.

17 The program of claim 15, wherein the meta information includes a title of the chart, a name of an axis, and a name of the entity included in a legend.

18. The program of claim 15, wherein the data information includes numerical information included in the chart.

19. The program of claim 15, wherein each data item of the data information is tokenized into a single token and included in the fourth embedding, and
in recording the data information included in the fourth embedding in the second data format, a tokenized data information is extracted from single tokens and recorded in the second data format.

20. The program of claim 19, wherein in extracting the data information from the single tokens, data information is simultaneously extracted by inputting the single tokens with a predefined repetitive template.
